(19) United States
(12) Patent Application Publication
(10) Pub. No.: US 2025/0230077 A1
(43) Pub. Date: Jul. 17, 2025

(54) SURFACE SLICK CLEANUP USING FATTY ACID SALTS

(71) Applicants: SAUDI ARABIAN OIL COMPANY, Dhahran (SA); KING FAHD UNIVERSITY OF PETROLEUM & MINERALS, Dhahran (SA)

(72) Inventors: Ahmed GMIRA, Dhahran (SA); Subhash AYIRALA, Dhahran (SA); Ali YOUSEF, Dhahran (SA); Theis SOLLING, Dhahran (SA); Ali BINABDI, Dhahran (SA)

(73) Assignees: SAUDI ARABIAN OIL COMPANY, Dhahran (SA); KING FAHD UNIVERSITY OF PETROLEUM & MINERALS, Dhahran (SA)

(21) Appl. No.: 18/410,881

(22) Filed: Jan. 11, 2024

(51) Int. Cl. C02F 1/68; C02F 101/32

(52) U.S. Cl. CPC C02F 1/681; C02F 2101/32; C02F 2303/18

(57) ABSTRACT

Fatty acids and metal cations may be used for petroleum spill remediation. For example, remediation methods may comprise: applying a fatty acid to a surface slick located on an aqueous fluid, the surface slick comprising an oleaginous substance; applying a metal cation to the surface slick after applying the fatty acid; reacting the fatty acid and the metal cation upon the surface slick to form a fatty acid salt; and interacting the fatty acid salt with a surface of the surface slick to reduce a surface area of the surface slick. Alternately, the fatty acid salt may be pre-formed before application to the surface slick.

### FIELD OF THE DISCLOSURE

The present disclosure generally relates to petroleum spill remediation, such as cleanup of a surface slick upon an aqueous fluid.

### BACKGROUND OF THE DISCLOSURE

Petroleum spill remediation conventionally encompasses three main approaches: physical remediation, chemical remediation, and biological remediation (bioremediation). An additional approach may include in situ burning of a petroleum spill; however, such approaches are typically discouraged due to their limited effectiveness and formation of harmful byproducts and air pollutants during combustion. Physical remediation may include mechanically collecting the petroleum spill for removal in a desired manner. Examples of techniques employed during physical remediation may include mechanical floating booms, skimmers, and physical absorbent materials. Chemical remediation may employ substances such as dispersants and solidifiers to alter a petroleum slick for promoting easier collection, environmental uptake, or bioremediation through native biological processes. Bioremediation approaches may utilize native, non-native, and/or bioengineered microbes to metabolize the petroleum as a means of cleanup. Such conventional approaches may have limitations with respect to their cost and effectiveness under various circumstances. For example, petroleum slicks may tend to form a thin film upon an aqueous fluid and spread out over a large area, which may make physical collection difficult and/or render chemical or biological remediation approaches ineffective.

### SUMMARY OF THE DISCLOSURE

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

Non-limiting example methods of the present disclosure may comprise: applying a fatty acid to a surface slick located on an aqueous fluid, the surface slick comprising an oleaginous substance; applying a metal cation to the surface slick after applying the fatty acid; reacting the fatty acid and the metal cation upon the surface slick to form a fatty acid salt; and interacting the fatty acid salt with a surface of the surface slick to reduce a surface area of the surface slick.

Non-limiting example methods of the present disclosure may comprise: applying a fatty acid salt comprising a fatty acid and a metal cation to a surface slick located on an aqueous fluid, the surface slick comprising an oleaginous substance; and interacting the fatty acid salt with a surface of the surface slick to reduce a surface area of the surface slick.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIGS. 1A-1C are diagrams illustrating methods for remediating a surface slick according to the present disclosure.

### DETAILED DESCRIPTION

Embodiments in accordance with the present disclosure generally relate to methods for petroleum spill remediation, such as cleanup of a surface slick upon an aqueous fluid.

The present disclosure provides cost-effective methods for removal of petroleum, crude oil, and other oleaginous substances from the surface of an aqueous fluid. The methods described herein may provide a remediation approach with robust environmental sustainability, decreased cost and time requirements, and operational simplicity relative to conventional approaches for remediating surface slicks formed from oleaginous substances of various types. In particular, the present disclosure provides methods for removing a surface slick from an aqueous fluid by using a fatty acid salt. The fatty acid salt comprises a fatty acid and a metal cation, such as a transition metal or rare earth metal cation. The fatty acid salt may be pre-formed and applied to the surface slick or formed in situ upon a surface of the surface slick. Surprisingly, the fatty acid salt may interact with the oleaginous substance to consolidate the surface slick into a decreased surface area to facilitate subsequent removal thereof (e.g., by skimming the surface slick or through an alternative remediation technique). In some aspects, the fatty acid salts may function like a “chemical boom” to contain the surface slick within a smaller area than usual. Without being bound by theory or mechanism, the fatty acid salt is believed to alter interfacial tension of the surface slick in accomplishing the foregoing.

As used herein, the term “aqueous body” and grammatical variations thereof refers to any body of water having an aqueous fluid therein. Examples of aqueous bodies may include, but are not limited to, a sea, a lake, a pond, an ocean, a river, subsurface water, and the like. Aqueous bodies may be found in commercial settings as well, such as evaporating ponds, cooling water tanks, water treatment facilities, and the like. A surface slick may be present upon any of the foregoing.

As used herein, the term “oleaginous substance” and grammatical variations thereof, refers to any hydrophobic substance (e.g., a hydrocarbon-based substance) that is capable of forming a surface slick upon the surface of an aqueous fluid within an aqueous body. Examples of oleaginous substances may include, but are not limited to, petroleum, oil (e.g., crude oil), bitumen, tar, synthetic hydrocarbons, the like, and any combination thereof.

As used herein, the term “aqueous fluid” refers to any fluid containing water as a majority component by volume. Aqueous fluids may include, but are not limited to, freshwater (e.g., lake water, municipal treated water, and the like), brine, produced water, formation water, wastewater, the like, and any combination thereof.

As used herein, the term “surface slick” refers to a thin film or layer of an oleaginous substance formed upon the surface of an aqueous fluid.

As used herein, the term “fatty acid” refers to an optionally unsaturated carboxylic acid containing about 6 or more carbon atoms.

As used herein, the term “fatty acid salt” refers to a fatty acid whose acidic proton has been removed and replaced with a metal cation.

The fatty acid and the metal cation may be applied to the surface slick separately, in which case the fatty acid salt may form upon a surface of the surface slick. Such methods of the present disclosure may comprise: applying a fatty acid to a surface slick located on an aqueous fluid, the surface slick comprising an oleaginous substance; applying a metal cation to the surface slick after applying the fatty acid; reacting the long-chain fatty acid and the metal cation upon the surface slick to form a fatty acid salt; and interacting the fatty acid salt with a surface of the surface slick to reduce a surface area of the surface slick. Preferably, the fatty acid and the metal cation may be delivered to the surface slick within separate fluids (e.g., a first fluid and a second fluid, respectively, such as first and second aqueous fluids).

Alternately, the fatty acid and the metal cation may be applied to the surface slick concurrently, including with the fatty acid and the metal cation being pre-reacted to form a fatty acid salt. Such methods of the present disclosure may comprise: applying a fatty acid salt comprising a long-chain fatty acid and a metal cation to a surface slick located on an aqueous fluid, the surface slick comprising an oleaginous substance; and interacting the fatty acid salt with a surface of the surface slick to reduce a surface area of the surface slick. Preferably, the fatty acid salt may be delivered to the surface slick within a second aqueous fluid.

The fatty acid salt may be introduced to the surface slick or formed upon a surface of the surface slick in any suitable manner. In some examples, the fatty acid may be applied to the surface slick within a first fluid (e.g., a first aqueous fluid), and the metal cation may be applied to the surface slick within a second fluid (e.g., a second aqueous fluid). Alternately, the fatty acid salt may be pre-formed and applied to the surface slick within a combined aqueous fluid. Each of the aqueous fluids may comprise a suspension, solution, or any combination thereof. That is, the fatty acid, the metal cation, and/or the fatty acid salt may be soluble, partially soluble, or insoluble within an aqueous fluid.

Fluids of the present disclosure (e.g., a first fluid, a second fluid, or a combined aqueous fluid) containing the fatty acid, the metal cation, or the fatty acid salt may comprise an aqueous fluid as a carrier fluid. Examples of suitable aqueous fluids may include, but are not limited to, freshwater (e.g., lake water, stream water, municipal treated water, and the like), brine, unsaturated salt solutions, seawater produced water, formation water, wastewater, the like, or any combination thereof.

Surface slicks that may be remediated according to the disclosure herein may likewise occur upon any of the foregoing types of aqueous fluids or other types of aqueous fluids. In particular examples, the surface slick may be present upon freshwater, seawater, or brine.

The fatty acid and the metal cation may undergo reaction and form the fatty acid salt in any suitable manner upon being combined together. Upon separate introduction to the surface of a surface slick, a fatty acid salt may form in situ upon the surface of the surface slick and provide the benefits described herein. Similar effects may be realized with a pre-formed fatty acid salt. Without being bound by theory, the fatty acid salt may alter the interfacial tension between the oleaginous substance and the aqueous fluid upon which the surface slick is present. In altering the interfacial tension, the fatty acid salt may promote formation of clusters (oil clusters) comprising the oleaginous substance, promote crystallization of the oleaginous substance upon the surface slick, the like, or any combination thereof.

Upon interacting the fatty acid salt with the oleaginous substance of the surface slick and/or the aqueous fluid bearing the surface slick, a reduction of the surface area of the surface slick may be realized. In non-limiting examples, the surface area of the surface slick may be reduced by about 1% to about 99%, such as about 50% to about 99%, or about 50% to about 80%, or about 60% to about 90%, or about 50% or greater, or about 80% or greater, or 90% or greater, relative to an initial surface area of the surface slick.

Following the reduction in surface area of the surface slick, the oleaginous substance of the surface slick may be removed from the surface of the aqueous fluid through any suitable means including, for example, skimming, pumping, absorbing, filtering, the like, or any combination thereof. One of ordinary skill in the art will be able to appropriately select and implement an appropriate method for removal of the surface slick from the aqueous body.

Suitable fatty acids for forming a fatty acid salt for use in the disclosure herein are not believed to be particularly limited. Suitable fatty acids may be straight chain or branched, and saturated or unsaturated. Preferable fatty acids may be straight chain fatty acids due to their ready availability from natural sources and relatively low cost. Illustrative fatty acids that may be suitable for use in the present disclosure include, for example, caproic acid, enanthic acid, caprylic acid, pelabonic acid, capric acid, undecylic acid, lauric acid, tridecylic acid, myristic acid, pentadecylic acid, palmitic acid, margaric acid, stearic acid, nonadecylic acid, arachidic acid, heneicosylic acid, behenic acid, trioscylic acid, lignoceric acid, pentacosylic acid, cerotic acid, carboceric acid, montanic acid, nonacosylic acid, melissic acid, crotonic acid, cervonic acid, linoleic acid, linolelaidic acid, linolenic acid, arachidonic acid, docosatetraenoic acid, myristoleic acid, palmitoleic acid, sappenic acid, vaccenic acid, paullinic acid, oleic acid, pinolenic acid, stearidonic acid, eleostearic acid, elaidic acid, gondoic acid, gadoleic acid, erucic acid, eicosenoic acid, eicosadiencoic acid, eicosatrienoic acid, eicosatetraenoic acid, docosadienoic acid, nervonic acid, mead acid, adrenic acid, the like, and any combination thereof.

Particularly suitable examples of suitable fatty acids may include a C8 to C26 fatty acid, or a C8 to C16 fatty acid, or a C8 to C12 fatty acid. Such fatty acids may be saturated or unsaturated. Fatty acids of the foregoing size ranges may allow for targeted solubility in various components (e.g., aqueous fluid, surface slick, the like) when used according to the present disclosure. Examples of suitable saturated fatty acids within the foregoing size ranges may include, but are not limited to, decanoic acid (capric acid), dodecanoic acid (lauric acid), the like, or any combination thereof. Lauric acid may be preferred for use in compositions and methods the present disclosure.

When introduced to the surface slick in a fluid, the concentration of the fatty acid in the fluid may vary over a considerable range. Preferably, the fatty acid is present below a saturation concentration for the fatty acid and/or the fatty acid salt in the fluid. In non-limiting examples, the fatty acid may have a concentration in the fluid ranging from about 0.1 wt % to about 5 wt %, or about 0.1 wt % to about 4.0 wt %, or about 0.1 wt % to about 3.0 wt %, or about 0.5 wt % to about 3.0 wt %, or about 0.5 wt % to about 2.0 wt %, or about 0.5 wt % to about 1.0 wt %, based on a total weight of the fluid.

A metal cation of the present disclosure may be delivered to the surface slick as a metal salt. Any suitable metal salt may be used, preferably a salt of a transition metal (e.g., a halide salt of a transition metal) or a salt of a rare earth metal. Examples of suitable metal salts may include, but should not be limited to, transition metal or rare earth salts that contain a copper (II) cation, a neodymium (III) cation, a cerium (III) cation, a zinc (II) cation, the like, or any combination thereof. Suitable counterions for the metal cations may include, but are not limited to, chlorides, bromides, iodides, nitrates, acetates, and the like. In particular examples of the present disclosure, the metal salt may comprise zinc (II) chloride.

When introduced to the surface slick in a fluid, the concentration of the metal cation in the form of a metal salt may vary over a considerable range in the fluid. Preferably, the metal salt is present below a saturation concentration for the metal salt in the fluid. As an example, the metal cation may have a concentration in the a fluid of the present disclosure ranging from about 2,500 ppm to about 10,000 ppm, or about 1,000 ppm to about 15,000 ppm, or about 2,500 ppm to about 12,500 ppm, or about 2,500 ppm to about 7,500 ppm, or about 2,500 ppm to about 5,000 ppm, or about 5,000 ppm to about 10,000 ppm, based on a total weight of the fluid.

The fatty acid and the metal cation may be present in similar concentration ranges within a combined aqueous fluid containing a pre-formed fatty acid salt. Overall, the concentration of the fatty acid salt may be present in the fluid in a concentration ranging from 0.25 wt % to about 6 wt %, or about 0.25 wt % to about 6 wt %, or about 0.25 wt % to about 5 wt %, or about 0.75 wt % to about 5 wt %, or about 0.75 wt % to about 4 wt %, or about 0.75 wt % to about 3 wt %, or about 0.75 wt % to about 2 wt %, based on a total weight of the fluid.

When interacting with the surface slick, all of the fatty acid may be converted to the corresponding fatty acid salt, or a portion of the fatty acid may remain as the free (protonated fatty acid).

Furthermore, the fatty acids, metal cations, metal salts, fatty acid salts and fluids containing the foregoing may further include one or more additional components suitable for achieving one or more desired functions (e.g., in addition to promoting a surface area reduction of the surface slick according to the disclosure herein). Examples of suitable additional components may include, but are not limited to, a salt, a weighting agent, an inert solid, an emulsifier, a dispersion aid, a viscosifying agent, a particulate, a foaming agent, a gas, a pH control additive, a crosslinker, a chelating agent, a scale inhibitor, a solvent, an oxidizer, the like, or any combination thereof. Suitable examples of the foregoing will be familiar to one having ordinary skill in the art.

Any of the fluids discussed herein may be mixed at a remote location from a job site and shipped thereto or may be mixed at a job site. In still other examples, mixing of the fluid(s) may take place on-the-fly as the fluid is delivered to the surface slick (e.g., with the fatty acid salt being formed in situ within the aqueous fluid). A person having ordinary skill in the art and the benefit of this disclosure will be able to consider these factors and determine whether remote mixing, on-site mixing, or any other suitable mixing protocol is most appropriate for a given implementation of the present disclosure.

Systems for introducing the fluids of the present disclosure to a surface slick may include one or more mixing and/or storage tanks for mixing and/or storing the fluids prior to their introduction to the surface slick. Systems for introducing fluids to a surface slick may comprise a pump suitable to convey a given fluid to the surface slick. The pump may comprise a single pump or may comprise multiple pumps. Given the benefit of the present disclosure, one having ordinary skill in the art will be able to select appropriate system component(s) (e.g., including a pump or combination of pumps) for a given application. Additional equipment (e.g., tanks, skimmers, the like) may be used for removing (e.g., skimming) and/or storing fluids (including oleaginous substance(s)) of the present disclosure after removal of a surface slick.

Additional non-limiting components may be present in systems suitable to introduce fluids according to the present disclosure will be familiar to persons having ordinary skill in the art and may include, for example, supply hoppers, valves, condensers, adapters, joints, gauges, sensors, compressors, pressure controllers, pressure sensors, flow rate controllers, flow rate sensors, temperature sensors, the like, or any combination thereof.

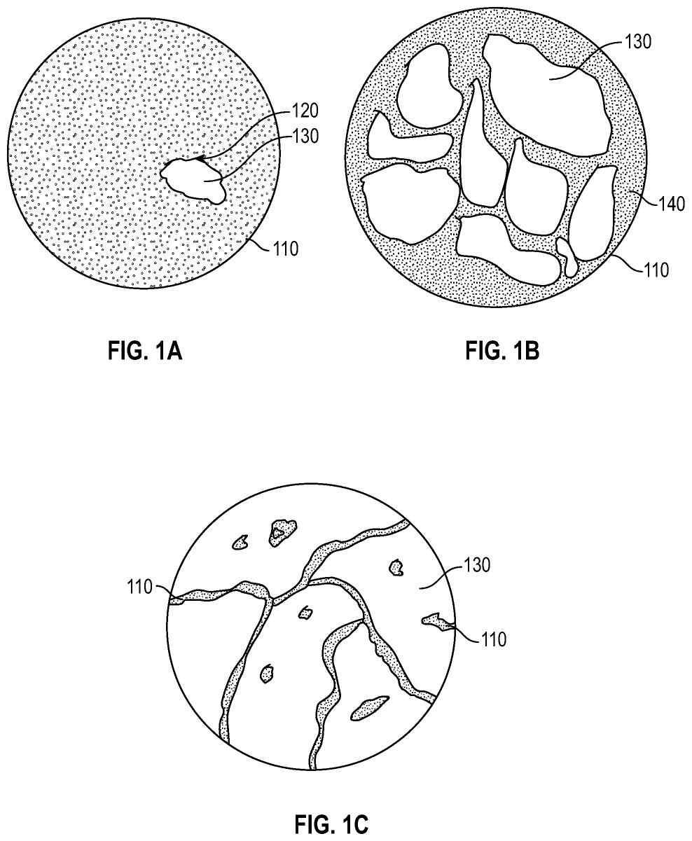

Embodiments of the present disclosure will now be described with reference to the drawings. FIGS. 1A-1C are diagrams illustrating methods for remediating a surface slick according to the present disclosure. In FIG. 1A, after application to surface slick 110, a fatty acid salt may disrupt a portion of surface slick 110 on aqueous body 130 at interface 120 and cause a reduction in size of surface slick 110. As shown in FIG. 1B, the fatty acid salt may continue to interact with surface slick 110 and cause additional clumping 140 to expose more of aqueous body 130. Subsequently, as shown in FIG. 1C, surface slick 110 may continue to be significantly decreased in size due to interaction with the fatty acid salt, thereby exposing still more of aqueous body 130 and confining surface slick 110 to facilitate subsequent skimming or other related removal techniques.

Embodiments disclosed herein include:

A. Method for mitigating surface slick. The methods comprise: applying a fatty acid to a surface slick located on an aqueous fluid, the surface slick comprising an oleaginous substance; applying a metal cation to the surface slick after applying the fatty acid; reacting the fatty acid and the metal cation upon the surface slick to form a fatty acid salt; and interacting the fatty acid salt with a surface of the surface slick to reduce a surface area of the surface slick.

B. Methods for mitigating a surface slick with a pre-formed fatty acid salt. The methods comprise: applying a fatty acid salt comprising a fatty acid and a metal cation to a surface slick located on an aqueous fluid, the surface slick comprising an oleaginous substance; and interacting the fatty acid salt with a surface of the surface slick to reduce a surface area of the surface slick.

Each of embodiments A and B may have one or more of the following additional elements in any combination:

Element 1: wherein the method further comprises: skimming at least a portion of the surface slick off the aqueous fluid after the surface area has been reduced.

Element 2: wherein the fatty acid is applied to the surface slick in a first fluid and the metal cation is applied to the surface slick in a second fluid.

Element 3: wherein the fatty acid has a concentration in the first fluid of about 0.5 wt % to about 2.0 wt %, based on a total weight of the first fluid.

Element 4: wherein the metal cation has a concentration in the second fluid of about 2,500 ppm to about 10,000 ppm, based on a total weight of the second fluid.

Element 5: wherein the metal cation comprises a transition metal cation or a rare earth metal cation.

Element 6: wherein the metal cation comprises a copper (II) cation, a neodymium (III) cation, a cerium (III) cation, a zinc (II) cation, or any combination thereof.

Element 7: wherein the metal cation comprises a zinc (II) cation.

Element 8: wherein the metal cation is applied to the surface slick as a metal chloride salt.

Element 9: wherein the fatty acid comprises a C8 to C26 fatty acid.

Element 10: wherein the fatty acid comprises dodecanoic acid.

Element 11: wherein the aqueous fluid comprises freshwater, seawater, or brine.

Element 12: wherein the surface area of the surface slick is reduced by about 50% or greater.

Element 13: wherein the surface area of the surface slick is reduced by about 80% or greater.

Element 14: wherein interacting the fatty acid salt with the surface of the surface slick promotes formation of a plurality of clusters comprising the oleaginous substance, crystallization of the oleaginous substance upon the surface slick, or any combination thereof.

Element 15: wherein the oleaginous substance comprises petroleum or crude oil.

Element 16: wherein the fatty acid salt is applied to the surface slick in a second aqueous fluid.

Element 17: wherein the fatty acid salt has a concentration in the second aqueous fluid ranging from about 0.75 wt % to about 3 wt %.

By way of non-limiting example, exemplary combinations applicable to A and B include, but are not limited to: 1 and 5; 1 and 5-6; 1 and 5-7; 5 and 6; 5-7; 1 and 9; 1 and 9-10; 9 and 10; 1 and 11; 11 and 12; 12 and 13; 11-13; 11-14; 1 and 15; and 11-15. Additional exemplary combinations applicable to A include, but are not limited to: 1 and 2; 1 and 3; 1 and 4; and 2-4. Additional exemplary combinations applicable to B include, but are not limited to: 16 and 17; 1 and 16; 1 and 16-17; 5 and 16-17; and 9 and 16-17.

Additional embodiments disclosed herein include:

Clause 1. A method comprising: applying a fatty acid to a surface slick located on an aqueous fluid, the surface slick comprising an oleaginous substance; applying a metal cation to the surface slick after applying the fatty acid; reacting the fatty acid and the metal cation upon the surface slick to form a fatty acid salt; and interacting the fatty acid salt with a surface of the surface slick to reduce a surface area of the surface slick.

Clause 2. The method of clause 1, further comprising: skimming at least a portion of the surface slick off the aqueous fluid after the surface area has been reduced.

Clause 3. The method of clause 1 or clause 2, wherein the fatty acid is applied to the surface slick in a first fluid and the metal cation is applied to the surface slick in a second fluid.

Clause 4. The method of clause 3, wherein the fatty acid has a concentration in the first fluid of about 0.5 wt % to about 2.0 wt %, based on a total weight of the first fluid.

Clause 5. The method of clause 3 or clause 4, wherein the metal cation has a concentration in the second fluid of about 2,500 ppm to about 10,000 ppm, based on a total weight of the second fluid.

Clause 6. The method of any one of clauses 1-5, wherein the metal cation comprises a transition metal cation or a rare earth metal cation.

Clause 7. The method of any one of clauses 1-6, wherein the metal cation comprises a copper (II) cation, a neodymium (III) cation, a cerium (III) cation, a zinc (II) cation, or any combination thereof.

Clause 8. The method of any one of clauses 1-7, wherein the metal cation comprises a zinc (II) cation.

Clause 9. The method of any one of clauses 1-8, wherein the metal cation is applied to the surface slick as a metal chloride salt.

Clause 10. The method of any one of clauses 1-9, wherein the fatty acid comprises a C8 to C26 fatty acid.

Clause 11. The method any one of clauses 1-10, wherein the fatty acid comprises dodecanoic acid.

Clause 12. The method of any one of clauses 1-11, wherein the aqueous fluid comprises freshwater, seawater, or brine.

Clause 13. The method of any one of clauses 1-12, wherein the surface area of the surface slick is reduced by about 50% or greater.

Clause 14. The method of any one of clauses 1-13, wherein the surface area of the surface slick is reduced by about 80% or greater.

Clause 15. The method of any one of clauses 1-14, wherein interacting the fatty acid salt with the surface of the surface slick promotes formation of a plurality of clusters comprising the oleaginous substance, crystallization of the oleaginous substance upon the surface slick, or any combination thereof.

Clause 16. The method of any one of clauses 1-15, wherein the oleaginous substance comprises petroleum or crude oil.

Clause 17. A method comprising: applying a fatty acid salt comprising a fatty acid and a metal cation to a surface slick located on an aqueous fluid, the surface slick comprising an oleaginous substance; and interacting the fatty acid salt with a surface of the surface slick to reduce a surface area of the surface slick.

Clause 18. The method of clause 17, further comprising: skimming at least a portion of the surface slick off the aqueous fluid after the surface area has been reduced.

Clause 19. The method of clause 17 or clause 18, wherein the fatty acid salt is applied to the surface slick in a second aqueous fluid.

Clause 20. The method of clause 19, wherein the fatty acid salt has a concentration in the second aqueous fluid ranging from about 0.75 wt % to about 3 wt %.

Clause 21. The method of any one of clauses 17-20, wherein the metal cation comprises a transition metal cation or a rare earth metal cation.

Clause 22. The method of any one of clauses 17-21, wherein the metal cation comprises a copper (II) cation, a neodymium (III) cation, a cerium (III) cation, a zinc (II) cation, or any combination thereof.

Clause 23. The method of any one of clauses 17-22, wherein the metal cation comprises a zinc (II) cation.

Clause 24. The method of any one of clauses 17-23, wherein the fatty acid comprises a C8 to C26 fatty acid.

Clause 25. The method of any one of clauses 17-24, wherein the aqueous fluid comprises freshwater, seawater, or brine.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains,” “containing,” “includes,” “including,” “comprises,” and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

What is claimed is:

1. A method comprising:
applying a fatty acid to a surface slick located on an aqueous fluid, the surface slick comprising an oleaginous substance;
applying a metal cation to the surface slick after applying the fatty acid;
reacting the fatty acid and the metal cation upon the surface slick to form a fatty acid salt; and
interacting the fatty acid salt with a surface of the surface slick to reduce a surface area of the surface slick.

2. The method of claim 1, further comprising:
skimming at least a portion of the surface slick off the aqueous fluid after the surface area has been reduced.

3. The method of claim 1, wherein the fatty acid is applied to the surface slick in a first fluid and the metal cation is applied to the surface slick in a second fluid.

4. The method of claim 3, wherein the fatty acid has a concentration in the first fluid of about 0.5 wt % to about 2.0 wt %, based on a total weight of the first fluid.

5. The method of claim 3, wherein the metal cation has a concentration in the second fluid of about 2,500 ppm to about 10,000 ppm, based on a total weight of the second fluid.

6. The method of claim 1, wherein the metal cation comprises a transition metal cation or a rare earth metal cation.

7. The method of claim 1, wherein the metal cation comprises a copper (II) cation, a neodymium (III) cation, a cerium (III) cation, a zinc (II) cation, or any combination thereof.

8. The method of claim 1, wherein the metal cation comprises a zinc (II) cation.

9. The method of claim 1, wherein the metal cation is applied to the surface slick as a metal chloride salt.

10. The method of claim 1, wherein the fatty acid comprises a C8 to C26 fatty acid.

11. The method of claim 1, wherein the fatty acid comprises dodecanoic acid.

12. The method of claim 1, wherein the aqueous fluid comprises freshwater, seawater, or brine.

13. The method of claim 1, wherein the surface area of the surface slick is reduced by about 50% or greater.

14. The method of claim 1, wherein the surface area of the surface slick is reduced by about 80% or greater.

15. The method of claim 1, wherein interacting the fatty acid salt with the surface of the surface slick promotes formation of a plurality of clusters comprising the oleaginous substance, crystallization of the oleaginous substance upon the surface slick, or any combination thereof.

16. The method of claim 1, wherein the oleaginous substance comprises petroleum or crude oil.

17. A method comprising:
applying a fatty acid salt comprising a fatty acid and a metal cation to a surface slick located on an aqueous fluid, the surface slick comprising an oleaginous substance; and
interacting the fatty acid salt with a surface of the surface slick to reduce a surface area of the surface slick.

18. The method of claim 17, further comprising:
skimming at least a portion of the surface slick off the aqueous fluid after the surface area has been reduced.

19. The method of claim 17, wherein the fatty acid salt is applied to the surface slick in a second aqueous fluid.

20. The method of claim 19, wherein the fatty acid salt has a concentration in the second aqueous fluid ranging from about 0.75 wt % to about 3 wt %.

21. The method of claim 17, wherein the metal cation comprises a transition metal cation or a rare earth metal cation.

22. The method of claim 17, wherein the metal cation comprises a copper (II) cation, a neodymium (III) cation, a cerium (III) cation, a zinc (II) cation, or any combination thereof.

23. The method of claim 17, wherein the metal cation comprises a zinc (II) cation.

24. The method of claim 17, wherein the fatty acid comprises a C8 to C26 fatty acid.

25. The method of claim 17, wherein the aqueous fluid comprises freshwater, seawater, or brine.
